(19) United States
(12) Patent Application Publication
(10) Pub. No.: US 2001/0005940 A1
(43) Pub. Date: Jul. 5, 2001

(54) Utility knife for precisely measured cutting

(76) Inventor: Hans-Georg Schwarz, Hamburg (DE)

Correspondence Address: FASSE PATENT ATTORNEYS, P.A., P.O. BOX 726, HAMPDEN, ME, 04444-0726, US

(21) Appl. No.: 09/753,044

(22) Filed: Dec. 28, 2000

(30) Foreign Application Priority Data
Dec. 28, 1999 (DE) 299 23 042.2

(51) Int. Cl. B26B 1/08

(52) U.S. Cl. 30/123; 30/162; 30/289

(57) ABSTRACT

A utility knife includes a handle, a cutting blade selectively extendable from or retractable into the handle, and a measuring tape received in and selectively extendable from a receiver housing that is rigidly connected to the handle. The measuring tape can be extended from its housing in a direction perpendicular to the cutting line of the cutting blade. A sight window is provided in the housing for viewing measurement marks on the measuring tape to adjust the measuring tape to a selected dimension at which the cutting blade is to carry out a cut. A glide shoe or hook is provided at the free end of the measuring tape, to act as a sliding guide for guiding the knife when making a cut.

### PRIORITY CLAIM

This application is based on and claims the priority under 35 U.S.C. §119 of German Patent Application 299 23 042.2, filed on Dec. 28, 1999, the entire disclosure of which is incorporated herein by reference.

1. Field of the Invention

The invention relates to a utility knife for the precisely measured cutting of materials and particularly sheet materials such as gypsum wallboard and the like, whereby the utility knife includes a handle or hand grip and a cutting blade that is selectively extendable from or retractable into the handle.

2. Background Information

Various configurations of so-called utility knives are known in the art, and are generally useful for cutting or scoring various types of materials, and especially sheet or panel materials such as gypsum wallboard (e.g. SHEETROCK®) in the building construction trade. Such utility knives typically include a handle or hand grip with a hollow interior space, and a cutting blade that is selectively extendable from or retractable into the hollow space within the handle. Namely, the cutting blade is retracted into the handle to be safely stored therein, or extended to the selected length for carrying out the actual cutting process.

In cutting various sheet or panel goods, such as gypsum wallboard for example, to required sizes for the further handling and use of such panel elements, it is often necessary to establish and maintain precise dimensions at which the cuts are to be carried out. In other words, the finished cut pieces must have a prescribed size for the ultimate intended use. Typically, a carpenter or other construction worker will therefore take a measurement and then mark the gypsum wallboard panel or other panel element using a separate tape measure and a pencil or marker or the like, and thereafter carry out the cuts along the marked cutting line using the utility knife, and possibly also using a straight edge to guide the cutting blade of the knife. In this context, it is complicated and time consuming to carry out the measuring, marking, and cutting using two or even three or four separate tools (namely a measuring tape, a pencil or marker, a straight edge, and a utility knife, for example), because each of these tools must be handled separately.

### SUMMARY OF THE INVENTION

In view of the above, it is an object of the invention to provide a single unitary tool for carrying out the required measuring and measured cutting of materials such as gypsum wallboard panels or the like. It is a further object of the invention to avoid the need of separately marking a cut line and then using a straight edge along which to carry out the cut, while still achieving a high precision straight line cut. The invention also aims to simplify the handling and the operations required for achieving a precisely measured cut using an easily handleable and compact device. The invention further aims to avoid or overcome the disadvantages of the prior art, and to achieve additional advantages, as apparent from the present specification.

The above objects have been achieved according to the invention in a utility knife with an integrated measuring tape. The combined device according to the invention comprises a hand grip or handle adapted to receive a cutting blade that may be selectively extended from the handle or retracted into the handle, and a receiver housing that is rigidly connected to the handle and that receives therein a selectively extendable measuring tape, which is selectively extendable in a direction perpendicular to an extension direction and a cutting line of the cutting blade. The receiver housing for the measuring tape has a sight window in which measuring indicia can be observed in order to selectively extend the measuring tape to a desired measurement, for carrying out a cut at a measured location using the cutting blade.

The inventive arrangement provides the advantages of a rigid coordination or integration of a measuring tape and a cutting knife and particularly the cutting blade of the cutting knife, so as to avoid the individual handling of a separate measuring tape and a separate utility knife, and particularly to avoid possible erroneous coordination between the separate measuring tape and cutting knife. Moreover, since the single integrated tool includes all necessary components for carrying out the measurement and the cutting, all of the necessary components are always readily available for carrying out any cut as required. There is no need to separately find and gather a tape measure, a pencil, a straight edge, and a utility knife, each time a cut is to be carried out.

In a further embodiment of the invention, the utility knife further includes a pivotable operating lever pivotably connected to and protruding from the handle and operatively connected to the cutting blade and the measuring tape. Thus, manually squeezing or pivoting the operating lever extends and/or locks the cutting blade in the required cutting position, and also locks the measuring tape at its adjusted extended position.

In order to guide the utility knife for precisely carrying out the cut along a properly measured cut line, without the need for marking the cut line with a pencil and using a straight edge or the like, the measuring tape of the present inventive utility knife preferably is equipped with an edge glide shoe or glide hook element at its distal free end. This edge glide shoe element can be hooked over and allowed to glide along a free edge of the panel material being cut, so that the cut line or score line being inscribed by the cutting blade will be located parallel to the respective free edge of the panel material at a prescribed spacing distance from that free edge of the panel material. Alternatively, by holding the edge glide shoe element at a fixed point, the cutting blade will inscribe a circle or circular arc as the cutting line.

In order that the present inventive utility knife is handy and readily available to the person using the knife, the knife preferably includes a hanging or holding loop extending from the end of the handle opposite the cutting blade. At least a portion of this hanging or holding loop is flexible or elastically extendable, so that the loop can be easily looped around the wrist and then remain elastically secured around the wrist of the person using the knife.

### BRIEF DESCRIPTION OF THE DRAWINGS

In order that the invention may be clearly understood, it will now be described in connection with an example embodiment, with reference to the accompanying drawings, wherein:

FIG. 1 is a schematic top view of a utility knife according to the invention; and

FIG. 2 is a schematic side view of the utility knife of FIG. 1, further equipped with a holding loop.

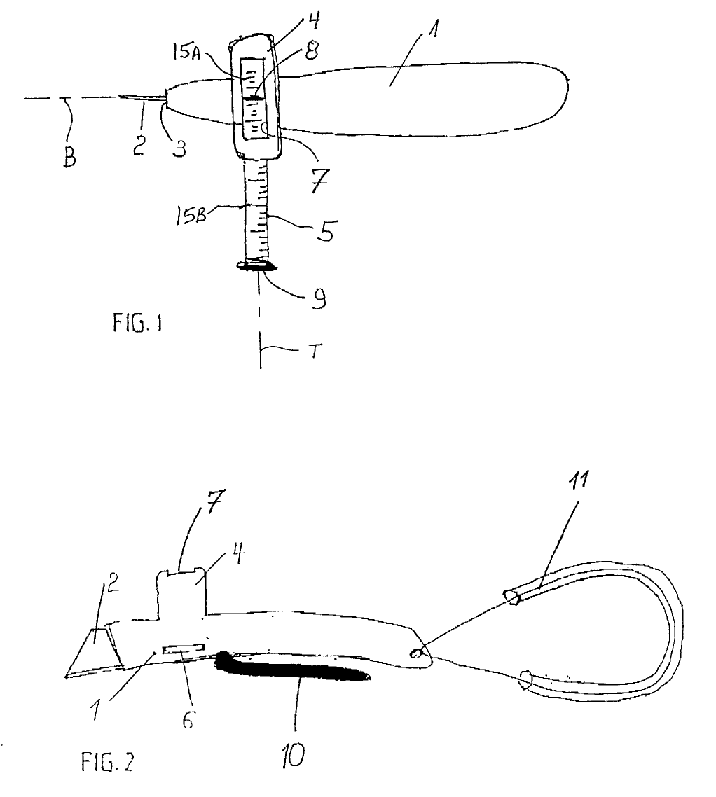

### DETAILED DESCRIPTION OF PREFERRED EXAMPLE EMBODIMENTS AND OF THE BEST MODE OF THE INVENTION

The illustrated embodiment of a utility knife according to the invention comprises a hand grip or handle 1, a cutting blade 2, and a receiver housing 4 for a retractable and extendable measuring tape 5. The cutting blade 2 is selectively extendable from or retractable into a hollow interior space of the handle 1 through an opening 3 at one end of the handle 1. This extension and retraction of the cutting blade 2 relative to the handle 1 can be carried out in any conventionally known manner using any conventionally known mechanism. For example, the blade may be releasably and exchangeably coupled to a blade holder that is slidable within the interior space of the handle 1 and is connected to an operating button or lever or the like. A suitable operating lever 10 of the invention will be described below.

The measuring tape 5 is preferably a flexible metal tape that is selectively rolled up within the housing 4 or unrolled and extended from the housing 4 through an opening 6, whereby the measuring tape 5 extends in a tape extension direction T that is perpendicular to the cutting line established by the blade extension direction B. The measuring tape 5 is preferably connected to a retracting spring within the housing 4 to bias or urge the measuring tape 5 to coil up within the housing 4. The particular configuration and mechanism of the measuring tape 5 and the retracting spring within the housing 4 can be according to any conventionally known extendable tape measure.

A special feature of the invention is that the measuring tape in its housing 4 is rigidly connected to the handle 1 of the utility knife, so as to establish and maintain a positive fixed orientation and dimensional relationship between the measuring tape 5 and the cutting blade 2. In this application, the housing 4 being “rigidly connected” to the handle 1 covers embodiments in which the housing 4 is integral (e.g. integrally molded or cast) with the handle 1, as well as embodiments in which the housing 4 and the handle are individual components but are rigidly secured to each other, e.g. by screws, rivets, snap fasteners, clips, weld joints, mating snap-together parts of the components, etc. In any event, as mentioned above, the components are rigidly oriented relative to each other so that the tape extension direction T is perpendicular to the cutting blade extension direction B, and the position of the cutting blade 2 perpendicular to the cutting blade extension direction B is fixed relative to the measuring tape 5.

In this context, the receiver housing 4 of the measuring tape 5 has a sight window 7 therein, provided with a reticle or other measurement indicator 8 for the accurate measured adjustment of the extended measuring tape 5. The reticle or indicator 8 thus has a fixed position relative to the cutting blade extension direction B on which the blade 2 lies, and preferably lies on the same plane as the cutting blade 2. The measuring tape 5 itself is provided with measuring markings 15A that are visible through the sight window 7 with reference to the reticle 8. Preferably, the measuring markings 15A that are visible through the sight window 7 are provided on a back or bottom surface of the measuring tape 5, while another set or scale of measuring markings 15B is provided on the top surface of the measuring tape 5.

The measuring markings 15A are offset or shifted relative to the measuring markings 15B, to account for the circumferential wrapping distance of the measuring tape 5 being wound up in the housing 4, and to account for the dimensional relationship between the measuring tape 5 and the extension direction B or the associated cutting plane of the cutting blade 2. Thus, the measuring markings 15A aligned with the reticle 8 in the sight window 7 will indicate the accurate distance from the extended free end of the measuring tape 5 to the cutting plane defined by the blade extension direction B, as measured in the tape extension direction T perpendicular to that cutting plane. The user of the utility knife does not need to carry out any calculation or off-setting of the measurement indicated in the sight window 7, in order to make the cut directly along the cutting plane at the intended measured location.

The extended free end of the measuring tape 5 is preferably equipped with an edge glide shoe element or glide hook 9, which may be hooked over and glide along a free edge of the panel material being cut. In this manner, it is ensured that the cutting line extends parallel to the existing free edge of the panel material, with a precisely defined spacing distance between the cutting line and the free edge of the panel material. Thus, the edge glide shoe element 9 acts as a cutting guide or fence for accurately positioning and holding the cutting blade 2 for performing the cut.

The present illustrated embodiment of the utility knife further includes an operating lever 10 as shown in FIG. 2. The operating lever 10 is pivotably connected to the handle 1 at a location where the user's hand can conveniently operate the lever 10 while gripping the handle 1. The operating lever 10 is operatively connected to the measuring tape 5 and to the cutting blade 2 by any conventionally known or suitable linkage. Squeezing the operating lever 10 closer to the handle 1 causes the cutting blade 2 to extend from the handle 1, and then fixedly holds the cutting blade 2 in this extended position. Furthermore, squeezing or pulling the operating lever 10 closer to the handle 1 simultaneously locks or fixes the measuring tape 5 at an extended position that was established by manually extending the measuring tape. For example, moving the operating lever presses a tape brake member against the measuring tape 5.

Thus, the utility knife can be used for making an accurate measured cut by simply manually extending the measuring tape 5 until the desired dimension is indicated by the reticle 8 on the scale of markings 15A in the sight window 7, and then squeezing the operating lever 10 so as to extend the cutting blade 2 and fix the measuring tape 5 in the proper extended position. Then, while still squeezing the operating lever 10, the glide shoe element 9 is hooked over the free edge of the panel material, and then the knife is drawn in a cutting direction with the glide shoe element 9 gliding along the free edge panel material and the cutting blade 2 cutting or scoring the panel material along the measured cutting line. Then, when the cut is completed, the user simply releases the operating lever 10, whereby the cutting blade 2 is automatically retracted into the handle 1 under a biasing spring force, and the measuring tape 5 is unlocked so that it retracts into the housing 4 biased by the retracting spring.

As further shown in FIG. 2, the present utility knife preferably also includes a hanging or holding loop 11 connected to the handle 1 at the end thereof opposite the cutting blade 2. The loop 11 is preferably at least partly flexible or elastically extendable. The loop can be looped over the wrist of a user of the knife, or can be looped and hung from a belt or the like being worn by the user. In this manner, the present utility knife is always handy and readily available for performing the next cut, but both hands of the user of the knife are free for other tasks as soon as the previous cut has been completed. Namely, after completing a cut, the user can simply let go of the utility knife and have his or her hands free, yet the utility knife remains readily available and at hand for carrying out the next cut.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A utility knife comprising:
a handle having an interior space therein and an opening communicating into said interior space;
a cutting blade movably arranged in said interior space so as to be selectively movably extendable out of said interior space through said opening along a cutting blade extension direction and to be selectively movably retractable into said interior space;
a tape receiver housing rigidly connected to said handle; and
a measuring tape arranged in said housing and selectively extendable from said housing in a tape extension direction that is perpendicular to said cutting blade extension direction;
wherein said tape receiver housing has measuring indicia therein, and a sight window therein in which said measuring indicia can be observed.

2. The utility knife according to claim 1, further comprising a blade lock adapted to selectively fix said cutting blade in a position extended out of said handle, and a tape lock adapted to selectively fix said measuring tape in a position extended out of said tape receiver housing.

3. The utility knife according to claim 1, wherein said measuring indicia include a reticle fixed with respect to said housing and a first set of measurement markings arranged on said measuring tape.

4. The utility knife according to claim 3, wherein said first set of measurement markings are arranged on a first surface of said measuring tape, and further comprising a second set of measurement markings arranged on a second surface of said measuring tape opposite said first surface.

5. The utility knife according to claim 4, wherein said first set of measurement markings and said second set of measurement markings are offset from each other.

6. The utility knife according to claim 1, further comprising an operating lever pivotably connected to said handle and operatively coupled to said cutting blade and to said measuring tape so as to selectively fix said cutting blade and said measuring tape in respective extended positions thereof by pivoting said lever relative to said handle.

7. The utility knife according to claim 1, further comprising an edge hook glider element arranged at a free distal end of said measuring tape protruding out of said housing.

8. The utility knife according to claim 1, further comprising a hanging and holding loop connected to said handle at an end thereof opposite said cutting blade, wherein at least a portion of said loop is flexible or elastically stretchable.
